(19) United States
(12) Patent Application Publication
(10) Pub. No.: US 2018/0290904 A1
(43) Pub. Date: Oct. 11, 2018

(54) ELECTROLYSIS SYSTEM FOR PRODUCING ELECTROLYZED WATER

(71) Applicant: Ozo Innovations Ltd., Kidlington, Oxfordshire (GB)

(72) Inventor: Stephen Philip GARDNER, Gloucestershire (GB)

(73) Assignee: Ozo Innovations, Ltd., Kidlington, Oxfordshire (GB)

(21) Appl. No.: 15/531,826

(22) PCT Filed: Dec. 4, 2015
(86) PCT No.: PCT/GB2015/053716

§ 371 Date: May 31, 2017

(30) Foreign Application Priority Data
Dec. 9, 2014 (GB) 1421871.3

(51) Int. Cl. C02F 1/461

(52) U.S. Cl. CPC C02F 1/4618; C02F 1/46109; C02F 2001/46147; C02F 2201/46135; C02F 2209/40; C02F 2201/46155; C02F 2209/02; C02F 2209/05; C02F 2201/46145

(57) ABSTRACT

The present invention provides an electrolysis system for producing an electrolyzed water composition. The system comprises a reservoir (2) comprising an aqueous electrolyte solution. The system further comprises an electrolytic flow cell (4) in fluid communication with the reservoir (2) to receive a feed stream comprising aqueous electrolyte solution. The cell (4) comprises a plurality of boron doped diamond electrodes, in which the electrodes are connected to a power supply operable to provide an over-potential to the electrolyte solution to produce an electrolyzed water feed stream comprising a plurality of active molecular and ionic species. The system further comprises a control system (8) operable to control the power supply unit (11) in dependence on the salt concentration of the electrolyte solution to provide a predetermined voltage to the cell. The predetermined voltage corresponds to the minimum voltage required to provide an optimum concentration of active species within the electrolyzed water

### FIELD OF THE INVENTION

The present invention relates to a method and a system for producing electrolyzed water under optimum processing conditions.

### BACKGROUND

The electrolysis of solutions containing ionic salts is an integral part of the process for producing electrolyzed water. Electrolysis of the solutions produces a range of active molecular and ionic species in the electrolyzed water, including in some cases O₃ and HOCl.

The production of active species is determined by a number of factors, including:
the conductivity of the solution as a result of the total dissolved salts in the solution;
the charge density (power) applied to the solution; and
the surface area of the electrodes, flow rate and/or exposure time (i.e. the contact time of the solution to the electrode).

In many applications, in for example the food and agriculture or horticulture industries, the concentrations of salts have to be limited due to potential sensitivities to high salinity solutions. There are also high capital and operational costs involved in the production of electrolyzed water, and it is therefore desirable to minimise the:
electrode size and/or
power requirement for electrolysis

There is therefore a need for a system and a method for the production of electrolyzed water with improved efficiency whilst optimising the production of active species.

### SUMMARY OF THE INVENTION

According to a first aspect of the present invention, there is provided an electrolysis system for producing an electrolyzed water composition, the system comprising:
a reservoir comprising an aqueous electrolyte solution;
an electrolytic flow cell in fluid communication with the reservoir to receive a feed stream comprising the aqueous electrolyte solution, in which the cell comprises at least one pair of electrodes, in which the electrodes are connected to a power supply operable to provide an over-potential to the electrolyte solution to produce an electrolyzed water feed stream comprising a plurality of active molecular and ionic species; and
a control system operable to control the power supply in dependence on the salt concentration of the electrolyte solution to provide a predetermined voltage to the cell, in which the predetermined voltage corresponds to the minimum voltage required to provide an optimum concentration of active species within the electrolyzed water.

The system may further comprise a heater operable to supply heat to the electrolyte solution feed stream and/or the electrolyte solution within the cell. The control system is preferably further operable to control the heater so as to control the temperature of the electrolyte solution. The control system is preferably operable to maintain the temperature of the electrolyte solution/electrolyte solution feed stream at a predetermined temperature or within a predetermined temperature range so as to optimise the conductivity for a given specific concentration of electrolytes, whilst also minimising heat related degradation of the active species, in order to produce an electrolyzed water feed stream having an optimum concentration of active molecular and ionic species. The control system is preferably operable to control the temperature of the electrolyte solution and/or electrolyte solution feed stream is between 25° C. and 40° C. The control system is preferably operable to control the power supply in dependence on the salt concentration and the temperature of the electrolyte solution within the cell to provide a predetermined voltage to the cell, in which the predetermined voltage corresponds to the minimum voltage required for the electrolyte solution at that temperature in order to provide an optimum concentration of active species within the electrolyzed water.

The system may further comprise a clean water supply operable to deliver a clean water feed stream to the electrolyzed water feed stream to produce an electrolyzed water composition feed stream.

The control system is preferably further operable to control the relative flow rates of at least one of the electrolyzed water feed stream, the clean water feed stream, and the electrolyzed water composition feed stream.

The system may further comprise a mixing chamber in fluid communication with the electrolyzed water feed stream and the clean water feed stream.

The system may further comprise at least one flow regulator for controlling the relative flow rates of at least one feed stream.

The electrolytic flow cell may for example be a parallel flow cell.

According to a second aspect of the present invention, there is provided a method for optimising the production of an electrolyzed water composition, comprising:
preparing an aqueous electrolyte solution;
introducing the aqueous electrolyte solution into an electrolytic cell comprising at least one pair of electrodes located within the electrolytic cell and arranged in use to be connected to a power supply; and
operating a power supply to apply a voltage to the electrolyte solution within the electrolytic cell to produce electrolyzed water comprising a plurality of active molecular and ionic species;
in which the method further comprises operating a control system to control the power supply in dependence on the salt concentration and conductivity of the electrolyte solution to provide a predetermined voltage to the cell, in which the predetermined voltage corresponds to the minimum voltage required to provide an optimum concentration of active species within the electrolyzed water.

The method may further comprise heating the electrolyte solution within the electrolytic cell. The method may further comprise heating the electrolyte solution feed stream. The method may further comprise operating the control system to control the temperature of the electrolyte solution feed stream and/or the electrolyte solution within the electrolytic cell. Preferably, the method operates the control system to control the temperature of the electrolyte solution feed stream and/or electrolyte solution within the cell to a temperature between 25° C. and 40° C. so as to optimise the conductivity of the electrolyte solution whilst minimising heat degradation of active species in order to produce an electrolyzed water feed stream comprising an optimum concentration of active species. The method preferably further comprises operating the control system to control the power supply in dependence on the salt concentration and the temperature of the electrolyte solution within the cell to provide a predetermined voltage to the cell, in which the predetermined voltage corresponds to the minimum voltage required for the electrolyte solution at that temperature in order to provide an optimum concentration of active species within the electrolyzed water.

The method may further comprise combining a feed of the electrolyzed water with a clean water feed stream. The method may further comprise combining and mixing the feed streams of the electrolyzed water and clean water within a mixing chamber.

The method may further comprise operating the control system to control the relative flow rates of at least one of: a feed stream comprising the electrolyte solution; the electrolyzed water feed stream, and the clean water feed stream, and any combination thereof.

### BRIEF DESCRIPTION OF FIGURES

FIG. 1 is a schematic flowchart of the system according to one embodiment of the present invention;

FIG. 2 is a graph illustrating the relationship between voltage and current density in order to produce an electrolyzed water composition having a given concentration of active molecular and ionic species for five different sodium chloride solutions having different electrical conductivities;

FIG. 3 is a graph illustrating the effect of increasing salt solution (sodium chloride) concentration on the concentration of active molecular and ionic species (free accessible chlorine—FAC) produced for a given constant cell area, charge density and temperature; and

FIG. 4 is a graph illustrating the effect of temperature on the conductivity of the solution.

### DETAILED DESCRIPTION

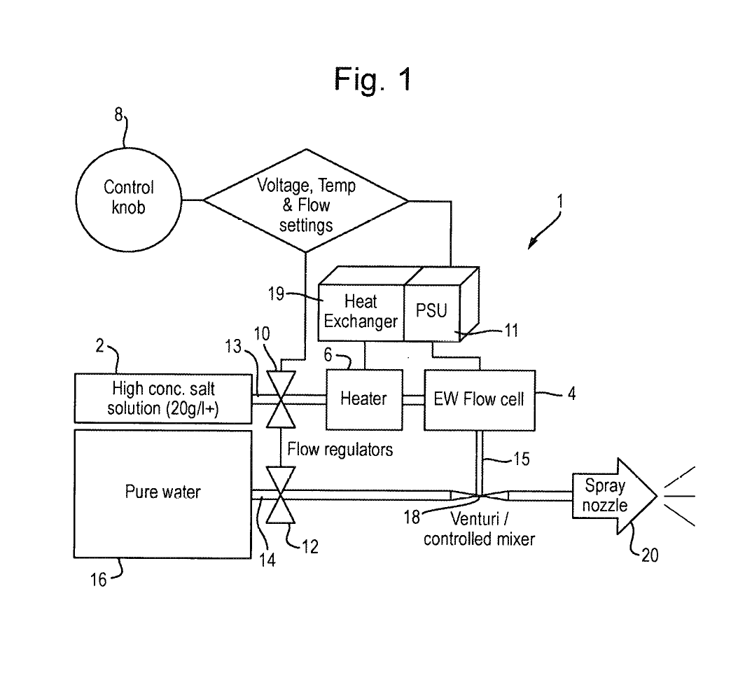

With reference to FIG. 1, the system 1 comprises a reservoir 2 comprising an aqueous electrolyte solution of a high concentration salt solution, for example a salt solution in which the salt concentration is equal to or greater than 20 g/l.

The reservoir 2 is in fluid communication with the electrolytic flow cell 4. The cell 4 comprises between 3-10, for example eight, electrodes (not shown). The electrodes are boron-doped diamond electrodes. It is however to be understood that the cell may contain any suitable number of electrodes, and that the electrodes may be made of any suitable material.

The electrolytic cell comprises a casing, between 3 to 10, for example eight, boron doped diamond electrodes (BDEs) located within the cell, and metal ‘contact plates’ used for transmitting charge across the electrolyte solution.

The BDEs are sheet-like components and are provided in a stack of between 3-10, for example eight, sheets. Each sheet is located at a fixed distance away from an adjacent sheet. The distance between adjacent sheets of BDEs provides a cell gap, which is preferably less than 5 mm, for example between approximately 2 and 3 mm. The BDEs are provided in a plastic frame. The BDEs transmit charge across the electrolyte solution, inducing a strong dipole and creating positively and negatively charged radicals on alternate surfaces of the diamonds.

The electrolyte solution may be introduced into the electrolytic cell in any suitable manner so as to produce electrolyzed water composition in a continuous process or in a batch process. In the continuous process, the electrolyte solution may be introduced at a suitable flow rate, such as for example at a flow rate in the range of from 0.1 to 100 l/min, for example in the range of from 3 to 5 l/min. In the batch process, the electrolyte solution may have a flow rate of approximately 16 l/min.

The electrodes (not shown) are connected to a power supply unit 11 operable to provide an over-potential to the electrolyte solution within the cell to produce an electrolyzed water feed stream 15 comprising a plurality of active molecular and ionic species. The feed stream 15 is in fluid communication with a mixer 18.

The system also comprises a pure water reservoir 16 in fluid communication with the mixer 18. The mixer 18 is a venturi/controlled mixer for mixing the electrolyzed water feed stream 15 with the pure water feed stream 14. It is to be understood that any suitable mixer can be used.

The system 1 also comprises a heater 6 located between the reservoir 2 and the electrolytic flow cell 4. The heater 4 is arranged to heat the electrolyte solution feed stream 13, to a predetermined temperature or to within a predetermined temperature range as and when required, as it flows from the reservoir 2 to the flow cell 4.

The system 1 also comprises flow regulators 10, 12 arranged to independently adjust the flow rates of the electrolyte feed stream 13 and the clean water feed stream 14 from the pure water reservoir 16.

The system 1 further comprises a control system 8 operable to control the power supply unit 11 so as to control the voltage applied across the at least one pair of electrodes. The control system 8 is also operable to control the heater 6 so as to control the temperature of the electrolyte feed stream as it enters the cell 4. It is to be understood that the heater can be provided in any suitable location to provide heat to the electrolyte feed stream and/or electrolyte within the flow cell 4. For example, the heater may be arranged to heat the electrolyte when it is present within cell 4. The control system 8 is also operable to control the flow regulators 10, 12 to independently control the flow rate of the respective feed streams 13, 14.

In a preferred embodiment, excess heat from the power unit can be supplied to the electrolytic cell to pre-heat the electrolyte solution to further optimise power usage by the system. This may be controlled by adjusting the power applied to thermoelectric pumps or heat coils whose heat sink (heat exchanger 19) connects the power unit 11 to the heating element arranged to heat the electrolyte solution.

The control system 8 in this embodiment is a single rotary knob to control the voltage applied across the electrodes, and the relative flow rates of the electrolyte solution, the electrolyzed water, the clean water feed, and/or the temperature of the electrolyte solution In order to provide a predetermined voltage across the electrodes in which the predetermined voltage is the minimum voltage required for the electrolyte solution at that temperature in order to provide an optimum concentration of active species within the electrolyzed water.

The control knob setting ranges from ‘clean water’ to ‘full strength’. Switching to ‘clean water’ would cause the flow rate, heating and voltage to be applied to zero.

The output from the mixer would be clean water. Switching to ‘full strength’ would mean that the flow rate of clean water to the mixer would be zero. The heating of the electrolyte solution and the voltage applied would be at their maximum settings. Intermediate settings between ‘clean water’ and ‘full strength’ would use different ratios of relative flow rates between the electrolyzed water feed and clean water into the mixer, and varying temperatures applied to the electrolyte solution, and varying voltage applied across the electrodes, which would generate electrolyzed water compositions comprising increasing concentrations of active species, increasing in a linear manner, whilst keeping the output solution's salt concentration within a preset window.

Although this embodiment comprises a single control knob, it is to be understood that the control system 8 may be operable by a digital display.

High salinity solutions require significantly less power to provide a given concentration of active species. Preferably, the electrolyte solution is a high salinity salt solution, for example a solution comprising a salt concentration of at least 20 g/l. The present invention therefore provides a method and system with improved energy efficiency and reduced cost implications for providing electrolyzed water compositions having a given concentration of active species.

The system of the present invention enables high concentration salt solution to be electrolyzed within the cell (optionally at a predetermined temperature and flow rate) whilst requiring a consistent, predetermined, minimum voltage to be applied across the electrodes in order to provide electrolyzed water having a predetermined concentration of active species.

The system and method of the present invention therefore involves the use and/or production of high salinity solutions which are likely to be corrosive, irritant and/or phytotoxic. The system of the present invention therefore optionally includes a mixing chamber, in which the high salinity electrolyzed water composition is diluted immediately after production within the chamber with pure water. The electrolyzed water composition is preferably diluted immediately after production and at the point of delivery to minimise the degradation of actives in the EW solution. The method and system of the present invention therefore enable the desired concentration of active species to be produced within the electrolyte solution whilst minimising the required power supply and/or electrode size, and also providing an output electrolyzed water composition with salt concentrations which are safe to deliver.

The present invention provides a system and method for the production of electrolyzed water compositions with reduced production costs. As there is a reduced power requirement to operate the system, there are lower operating costs and a reduced carbon footprint associated with the system and method of the present invention. Due to the optimisation of the process parameters the size and cost of the electrolytic cell can be reduced.

### EXAMPLE 1

### Effect of Salt Concentration on Voltage Required

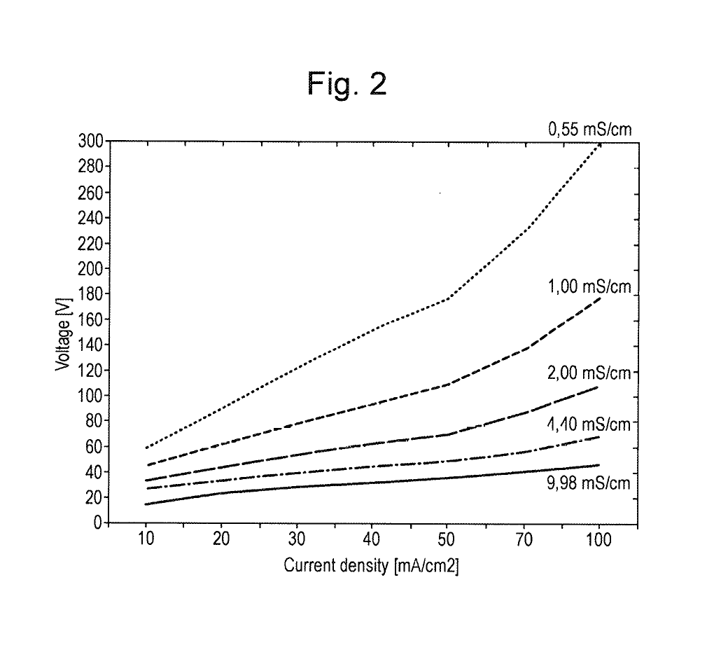

With reference to FIG. 2, five different electrolyte solutions comprising sodium chloride solutions of varying salt concentrations were investigated in order to identify the relationship between the voltage required to be supplied to the cell in order to obtain electrolyzed water comprising a predetermined concentration of active species.

The sodium chloride solutions investigated had conductivity values, directly related to the concentration of the salt solutions, of 0.55 mS/cm, 1.00 mS/cm, 2.00 mS/cm, 4.40 mS/cm and 9.98 mS/cm respectively. The conductivity of a solution increases as the concentration of the salt solution increases.

It can be seen from FIG. 2 that the amount of voltage required to be supplied to the cell in order to provide electrolyzed water comprising a predetermined concentration of active species decreases as the conductivity of the salt solutions increases. Therefore, less voltage is required to be supplied to more concentrated salt solutions in order to produce electrolyzed water having a predetermined concentration of active species, compared to more dilute salt solutions which have lower conductivity values.

It can be seen for example that the power required to provide electrolyte water having a predetermined concentration of active species is approximately a factor of 6 greater for a sodium chloride solution having a conductivity value of 0.55 mS/cm than for a sodium chloride solution having a conductivity value of 10 mS/cm.

The control system of the system of the present invention is therefore operable to control the power supplied to the electrodes within the cell in dependence of the concentration of the electrolyte solution, for example the conductivity of the electrolyte solution, in order to optimise the voltage required to produce electrolyzed water having a given concentration of active species. The present invention therefore provides a system and method with improved energy efficiency (and reduced cost implications) for providing electrolyzed water having a given concentration of active species.

### EXAMPLE 2

### Relationship Between Salt Concentration and the Concentration of Active Species Produced by Electrolysis

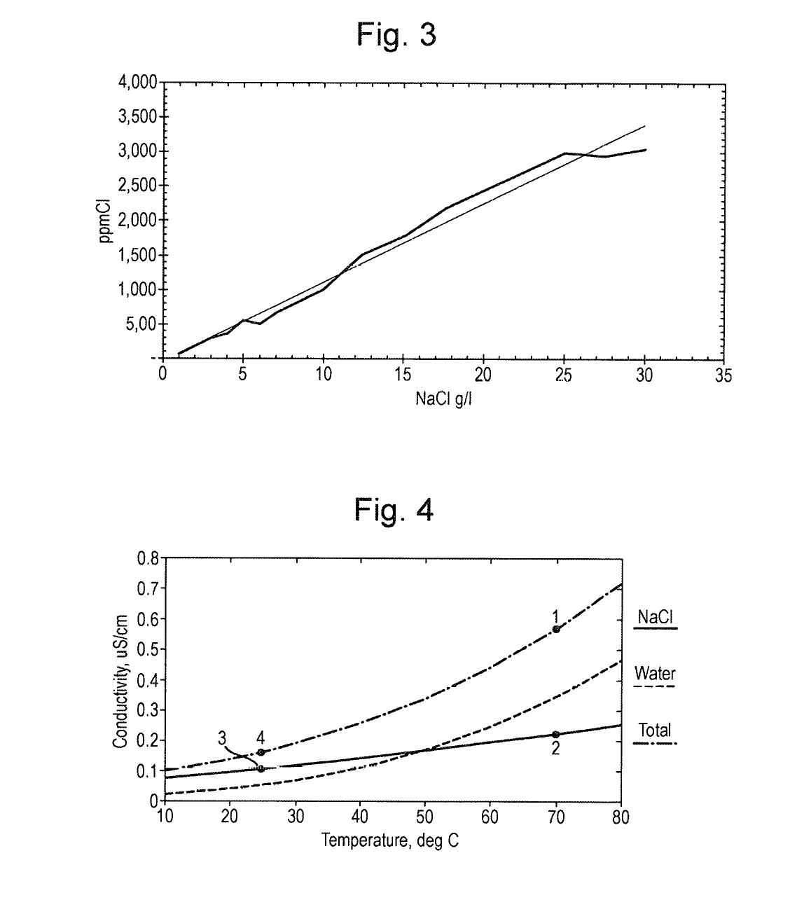

Sodium chloride solutions were introduced into the reservoir of the system of FIG. 1. The concentration of salt within the sodium chloride solution of the electrolyte varied, however all other operating conditions including heat and voltage remained the same for the system. As can be seen from FIG. 3, the concentration of active species within the electrolyzed water produced in the electrolysis cell is directly proportional to the concentration of sodium chloride within the solution. As the concentration of salt within the electrolyte solution increases, the concentration of active species within the resultant electrolyzed water also increases.

### EXAMPLE 3

### Relationship Between Temperature and Conductivity of the Solution

FIG. 4 illustrates the relationship between temperature and conductivity for a saline solution, a water solution, and a combined saline and water solution. It can be seen that as a general rule, as the temperature increases so does the conductivity of the solution increase. The increase in conductivity is more marked for the pure water solution than it is for the saline solution (NaCl). From FIG. 4 it can be seen that as the temperature rises from 10° C. to 30° C., the conductivity of the saline solution (NaCl) approximately doubles. This increase in conductivity indicates that significantly reduced power would be required to be supplied to the electrolyte solution at the higher temperature, in order to provide electrolyzed water comprising a given concentration of active species.

It is also however known that the temperature of the solution is a major contributing factor towards the instability of electrolyzed water compositions. Preferably, the temperature of the electrolyte solution is maintained within a temperature range of between 25° C. and 40° C. at which the lowest power can be supplied to the cell in order to generate the highest concentration of active species for a given charge density and salt concentration.

1. An electrolysis system for producing an electrolyzed water composition, the system comprising:
a reservoir comprising an aqueous electrolyte solution;
an electrolytic flow cell in fluid communication with the reservoir to receive a feed stream comprising the aqueous electrolyte solution, in which the cell comprises at least one pair of electrodes, in which the electrodes are connected to a power supply operable to provide an over-potential to the electrolyte solution to produce an electrolyzed water feed stream comprising a plurality of active molecular and ionic species; and
a control system operable to control the power supply in dependence on the salt concentration of the electrolyte solution to provide a predetermined voltage to the cell, in which the predetermined voltage corresponds to the minimum voltage required to provide an optimum concentration of active species within the electrolyzed water.

2. A system as claimed in claim 1, further comprising a heater operable to supply heat to the electrolyte solution within the electrolytic flow cell.

3. A system as claimed in claim 2, in which the control system is further operable to control the temperature of the electrolyte solution.

4. A system as claimed in claim 3, in which the control system is operable to control the power supply in dependence on the salt concentration and the temperature of the electrolyte solution within the cell to provide a predetermined voltage to the cell.

5. A system as claimed in claim 1, further comprising a clean water supply in fluid communication with the electrolyzed water feed stream.

6. A system as claimed in claim 5, further comprising a mixing chamber in fluid communication with the electrolyzed water feed stream and the clean water feed stream.

7. A system as claimed in claim 1, in which the system comprises at least one flow regulator for controlling the relative flow rates of at least one feed stream.

8. A system as claimed in claim 1, in which the control system is further operable to control the relative flow rates of at least one of: the electrolyte solution feed stream; the electrolyzed water feed stream, the clean water feed stream, or any combination thereof.

9. A method for optimising the production of an electrolyzed water composition, comprising:
preparing an electrolyte solution;
introducing the electrolyte solution into an electrolytic cell comprising at least one pair of electrodes located within the electrolytic cell and arranged in use to be connected to a power supply; and
operating a power supply to apply a voltage to the electrolyte solution within the electrolytic cell to produce electrolyzed water comprising a plurality of active molecular and ionic species; in which the method further comprises operating a control system to control the power supply in dependence on the salt concentration and conductivity of the electrolyte solution to provide a predetermined voltage to the cell, in which the predetermined voltage corresponds to the minimum voltage required to provide an optimum concentration of active species within the electrolyzed water.

10. A method as claimed in claim 9, further comprising heating the electrolyte solution.

11. A method as claimed in claim 10, further comprising operating the control system to control the temperature of the electrolyte solution within the electrolytic cell.

12. A method as claimed in claim 11, further comprising operating the control system to control the power supply in dependence on the salt concentration and the temperature of the electrolyte solution within the cell to provide a predetermined voltage to the cell.

13. A method as claimed in claim 9, further comprising combining a feed of the electrolyzed water with a clean water feed stream.

14. A method as claimed in claim 13 further comprising operating the control system to control the relative flow rates of at least one of: a feed stream comprising the electrolyte solution; the electrolyzed water feed stream, and the clean water feed stream, and any combination thereof.
